(19) United States
(12) Patent Application Publication
(10) Pub. No.: US 2020/0011457 A1
(43) Pub. Date: Jan. 9, 2020

(54) WATER PASSING COMPONENT, AND LASER WELDING DEVICE AND WELDING METHOD THEREOF

(71) Applicant: Youshi (Xiamen) Sanitary Ware Industrial Co., Ltd., Xiamen (CN)

(72) Inventor: Zhangsen YOU, Xiamen (CN)

(73) Assignee: Youshi (Xiamen) Sanitary Ware Industrial Co., Ltd., Xiamen (CN)

(21) Appl. No.: 16/265,997

(22) Filed: Feb. 2, 2019

(30) Foreign Application Priority Data
Jul. 3, 2018 (CN) 201810713170.2
Jul. 3, 2018 (CN) 201821040298.9
Oct. 10, 2018 (CN) 201821637491.0

(51) Int. Cl. F16L 13/02; B23K 26/282

(52) U.S. Cl. CPC F16L 13/02; B23K 2101/06; B23K 26/282

(57) ABSTRACT

A water passing component, a laser welding device and a welding method thereof are presented. The water passing component comprises a hose and a hose joint, the hose joint and the hose matched and connected to form a connecting and matching position. The connecting and matching position can be melted under laser beams to weld the hose and the hose joint into a whole; the width of a gap of a weld matching surface corresponding to the connecting and matching position is less than 0.075 mm. The present invention melts the connecting and matching position using the laser welding technology to weld the hose and the hose joint into a whole. The transparency of the hose and the hose joint is not limited, and there is no requirement for the transparency of the hose and the hose joint, thereby reducing production cost, increasing production efficiency and expanding use.

### TECHNICAL FIELD

The present invention relates to the technical field of water pipe fittings, and in particular to a water passing component, and a laser welding device and a welding method thereof.

### BACKGROUND

With the increasing improvement of the living standard of people, there are higher requirements for the quality of the living environment. Taps, fittings and other water passing components used in household kitchen and toilet are often made of copper material. However, the copper material contains a certain proportion of lead, arsenic and other chemical components harmful to human bodies, which will affect the health of consumers.

In order to overcome the defects of the material, the water passing components of copper material are innovated technically by many sanitary ware companies on the market. For example, better material is used to replace the copper material. At present, plastics such as PE and PEX are used widely. However, because these plastics have a heat-resistance temperature of about 60° C. and cannot be used under high-temperature hot water environments for long, the existing water passing components are made of PERT material. PERT is a non-crosslinked polyethylene pipe that can be used in hot water, and is also a medium density polyethylene pipe. It not only has the characteristic of high temperature resistance, but also has the characteristics of good flexibility, good pressure resistance, no toxicity, no taste, no pollution and low temperature resistance, and is especially suitable for the material of the water passing components. Furthermore, the water passing components are made of plastic such as PERT instead of the copper material, thereby substantially reducing material cost and part processing cost and reducing the harm of heavy metal contained in the water passing components of the copper material to the human bodies, so that market competitiveness of the product is enhanced.

### SUMMARY

The present application is created based on the knowledge and discovery of the inventor for the following problems:

When a water passing component made of plastic material is connected with a water outlet component, connecting technologies and methods such as vibration friction welding technology, ultrasonic welding technology and hot plate welding technology are mainly adopted in the related art. However, when the hot plate welding technology is used, it has the defects of easy adhesion of plastic to a hot plate and long cycle time; when the vibration friction welding technology is used, the shape of the component is limited and the component is easy to wear and produce polymer dust; and when the ultrasonic welding technology is used, the size of a weldment is limited and the weldment is easy to generate resonance.

The present invention aims to solve one of technical problems in the above background at least to a certain extent. To this end, the first purpose of the present invention is to propose a water passing component. A connecting and matching position is melted using a laser welding technology to weld the hose and the hose joint into a whole. The transparency of the hose and the hose joint is not limited, and there is no requirement for the transparency of the hose and the hose joint, thereby reducing production cost, increasing production efficiency and expanding use range.

The second purpose of the present invention is to propose a laser welding device of a water passing component.

The third purpose of the present invention is to propose a welding method of a water passing component.

To achieve the above purposes, a water passing component proposed in the embodiment of the first aspect of the present invention comprises: a hose; and a hose joint, wherein the hose joint and the hose are matched and connected to form a connecting and matching position; the connecting and matching position can be melted under laser beams to weld the hose and the hose joint into a whole; and the width of a gap of a weld matching surface corresponding to the connecting and matching position is less than 0.075 mm.

According to the water passing component in the embodiments of the present invention, the connecting and matching position is melted using a laser welding technology to weld the hose and the hose joint into a whole. The width of the gap of the weld matching surface corresponding to the connecting and matching position is limited to be less than 0.075 mm. In this way, during laser welding, the transparency of the hose and the hose joint is not limited, and there is no requirement for the transparency of the hose and the hose joint, thereby reducing production cost, increasing production efficiency and expanding use range.

According to one embodiment of the present invention, the hose joint is sleeved on the end part of the hose, wherein the head end of the hose and the tail end of the hose joint are abutted against each other and are welded into a whole through melting; at least one of the hose and the hose joint is made of melting material which can be melted under the laser beams; or at least one of the head end of the hose and the tail end of the hose joint is coated with a coating made of the melting material which can be melted under the laser beams; or a melting element made of the melting material which can be melted under the laser beams is arranged between the head end of the hose and the tail end of the hose joint.

According to another embodiment of the present invention, the hose joint comprises a connecting part; the connecting part can extend into the hose and is closely matched with the inner wall of the hose; the outer surface of the connecting part is provided with a screw thread; and the screw thread rotatably slides along the inner wall of the hose when the hose joint rotates, to insert the connecting part into the hose.

To achieve the above purposes, a laser welding device of a water passing component is proposed in the embodiment of the second aspect of the present invention, comprising a hose joint clamping part and a hose clamping part; each of the hose joint clamping part and the hose clamping part is composed of more than two opening-closing clamping components; a first holding cavity for clamping and fixing the hose joint is arranged in the hose joint clamping part; the shape of the first holding cavity is matched with the external shape of the hose joint; a second holding cavity for clamping and fixing the hose is arranged in the hose clamping part; the shape of the second holding cavity is matched with the external shape of the hose; the hose clamping part can enter the hose joint clamping part under the action of a drive device and can enable the head end of the hose clamped and fixed by the hose clamping part to be opposite to and abutted against the tail end of the hose joint clamped and fixed by the hose joint clamping part; the side wall of the hose joint clamping part is provided with slits through which the laser beams passes; the slits are arranged along the circumference of the side wall of the hose joint clamping part; a plurality of lasers are uniformed arranged outside the slits; after the laser beams emitted by the lasers pass through the slits, a plane laser beam distributed along the circumferential wall of the hose joint is formed; the laser beams correspond to the abutting surface between the head end of the hose and the tail end of the hose joint; and when the laser beams irradiate, the melting material of the abutting surface between the head end of the hose and the tail end of the hose joint is simultaneously melted and then the head end of the hose and the tail end of the hose joint are welded into a whole.

According to the laser welding device of the water passing component in the embodiments of the present invention, after the laser light emitted by the lasers passes through the slits, a plane laser beam distributed along the circumferential wall of the hose joint is formed. During irradiation, the melting material of the abutting surface between the head end of the hose and the tail end of the hose joint is simultaneously melted. Thus, in the welding process, the water passing component does not need to rotate, thereby shortening the processing cycle, increasing the efficiency and avoiding insufficient melting of the melting material due to easy deviation generated in clamping and positioning the hose. Therefore, the manufactured connecting structure has a joint strength higher than 300 psi during a burst pressure test, and also has higher strength and better safety.

To achieve the above purposes, a welding method of a water passing component is proposed in the embodiment of the third aspect of the present invention, wherein the water passing component comprises a hose and a hose joint sleeved to the end part of the hose and the welding method comprises the following steps: abutting the head end of the hose against the tail end of the hose joint, and welding into a whole after the melting material is melted under laser beam irradiation, wherein during melting welding, the width of a gap of a weld matching surface between the head end of the hose and the tail end of the hose joint is less than 0.075 mm; the melting thickness of the melting material is 3-6 mm; the light sources of the laser beams are yttrium aluminum garnet lasers or diode lasers; and the wavelength of the laser beams is 0.80-1.06 μm.

According to the welding method of the water passing component in the embodiments of the present invention, one plane laser beam is adopted. During irradiation, the melting material of the abutting surface between the head end of the hose and the tail end of the hose joint is simultaneously melted. Thus, in the welding process, the water passing component does not need to rotate, thereby shortening the processing cycle, increasing the efficiency and avoiding insufficient melting of the melting material due to easy deviation generated in clamping and positioning the hose. Therefore, the manufactured connecting structure has a joint strength higher than 300 psi during a burst pressure test, and also has higher strength and better safety.

### DESCRIPTION OF DRAWINGS

FIG. 1 is a cross-section schematic diagram of a water passing component according to one embodiment of the present invention;

FIG. 2 is a cross-section schematic diagram of a water passing component according to another embodiment of the present invention;

FIG. 3 is a cross-section schematic diagram of a water passing component according to yet another embodiment of the present invention;

FIG. 4 is a cross-section schematic diagram of a water passing component according to an implementation mode of one embodiment of the present invention;

FIG. 5 is a cross-section schematic diagram of a water passing component according to another two implementation modes of one embodiment of the present invention;

FIG. 6 is a relationship curve chart between welding strength of a water passing component and width of a gap of a weld matching surface according to embodiments of the present invention;

FIG. 7 shows structural schematic diagrams of reflected beams generated after laser beams respectively irradiate amorphous plastic and semi-crystalline plastic;

FIG. 8 is a relationship curve chart of the influence of a microcrystal diameter on laser absorption performance;

FIG. 9 is a relationship curve chart between melting thickness of melting material and the required laser power for material thickness;

FIG. 10 is a curve chart of comparison of optical performance of three different light sources of laser beams;

FIG. 11 is a diagram of absorption effects of two different light sources;

FIG. 12 is a relationship curve chart between the content of glass fibers in melting material and optical performance;

FIG. 13 is a relationship curve chart between the content of a colorant in melting material and optical performance;

FIG. 14 is a structural schematic diagram of a laser welding device of a water passing component according to one embodiment of the present invention;

FIG. 15 is a schematic diagram of plane laser beams distributed along a circumferential wall of a welding position and formed by laser light emitted by lasers according to one embodiment of the present invention; and

FIG. 16 is a cross-section schematic diagram of a water passing component according to another embodiment of the present invention.

### DETAILED DESCRIPTION

Embodiments of the present invention will be described below in detail. Examples of the embodiments are shown in drawings, wherein same or similar reference signs refer to same or similar elements or elements having same or similar functions from beginning to end. Embodiments described below by reference to the drawings are exemplary embodiments, and are used for explaining the present invention, and shall not be understood as a limitation to the present invention.

To better understand the above technical solution, exemplary embodiments of the present invention will be described below in more detail with reference to the drawings. Although the exemplary embodiments of the present invention are shown in the drawings, it should be understood that the present invention can be realized in various forms, and shall not be limited by the embodiments elaborated herein. On the contrary, the purpose of providing the embodiments is to understand the present invention more thoroughly and to completely communicate the scope of the present invention to those skilled in the art.

As shown in the drawings, the water passing component proposed in the embodiments of the present invention comprises: a hose 1 and a hose joint 2. The hose joint 2 and the hose 1 are matched and connected to form a connecting and matching position; the connecting and matching position can be melted under laser beams to weld the hose 1 and the hose joint 2 into a whole; and the width of a gap of a weld matching surface corresponding to the connecting and matching position is less than 0.075 mm.

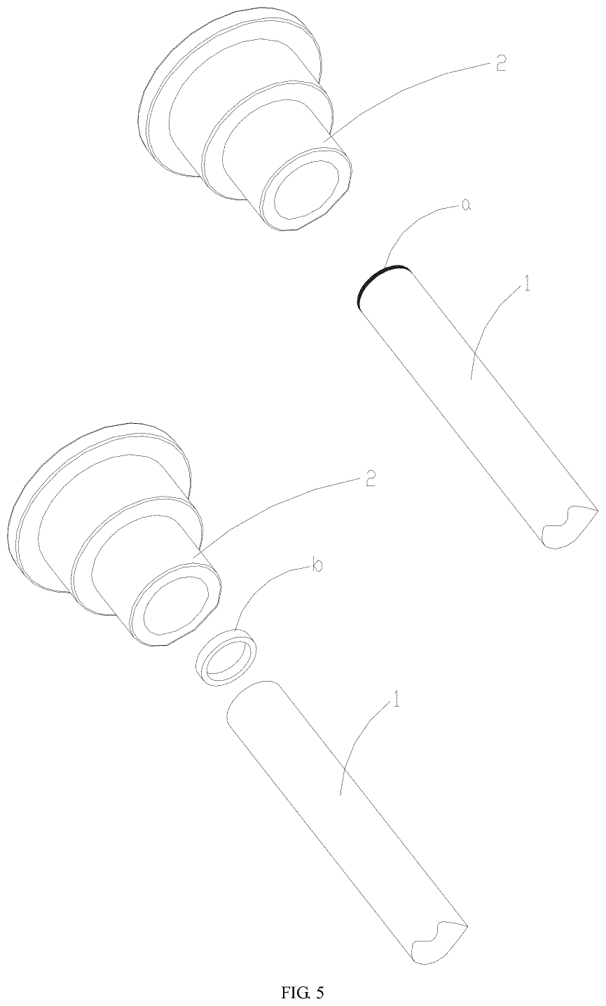

It can be understood that, as shown in FIG. 4, the hose joint 2 may be sleeved on the end part of the hose 1; the head end of the hose 1 and the tail end of the hose joint 2 are abutted against each other and are welded into a whole through melting; and then, the width of a gap of a weld matching surface between the head end of the hose 1 and the tail end of the hose joint 2 is less than 0.075 mm.

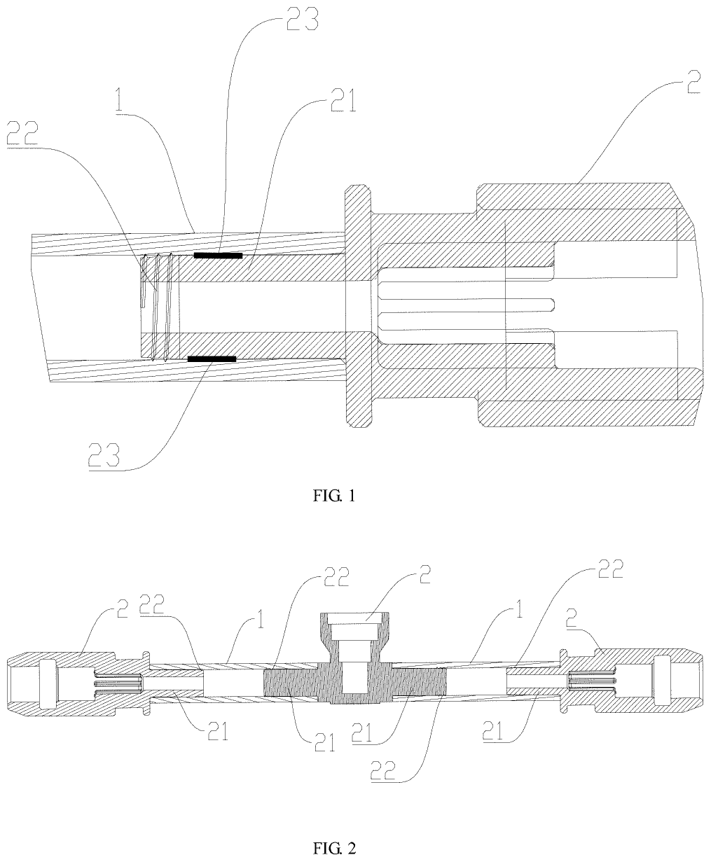

Or, as shown in FIG. 1, the hose joint 2 comprises a connecting part 21; the connecting part 21 can extend into the hose and is closely matched with the inner wall of the hose 1; the outer surface of the connecting part 21 is provided with a screw thread 22; and the screw thread 22 rotatably slides along the inner wall of the hose when the hose joint 2 rotates, to insert the connecting part 21 into the hose. In this way, the connecting and matching position of the connecting part 21 and the hose 1 can be melted under the laser beams to weld into a whole.

According to the water passing component in the embodiments of the present invention, the connecting and matching position is melted using a laser welding technology to weld the hose and the hose joint into a whole. The width of the gap of the weld matching surface corresponding to the connecting and matching position is limited to be less than 0.075 mm. In this way, during laser welding, the transparency of the hose and the hose joint is not limited, and there is no requirement for the transparency of the hose and the hose joint, thereby reducing production cost, increasing production efficiency and expanding use range.

Further, as one embodiment, as shown in FIG. 1 to FIG. 3, the water passing component comprises a hose 1 and a hose joint 2. As shown in FIG. 1 or FIG. 2, the hose joint 2 comprises a connecting part 21; the connecting part 21 can extend into the hose and is closely matched with the inner wall of the hose 1; the outer surface of the connecting part 21 is provided with a screw thread 22; and the screw thread 22 rotatably slides along the inner wall of the hose when the hose joint 2 rotates, to insert the connecting part 21 into the hose. Moreover, the connecting and matching position of the connecting part 21 and the hose 1 can be melted under the laser beams to weld into a whole.

According to one embodiment of the present invention, the screw thread 22 is a tapping screw thread; and the tapping screw thread is arranged in the position of the head of the outer surface of the connecting part 21, as shown in FIG. 2 specifically.

In this way, when rotating, the connecting part with the tapping screw thread can automatically advance without any propelling force, thereby realizing quick and convenient installation and increasing the efficiency.

In the embodiment, general expansion straight insertion is changed into a screwing mode for connection with the hose, which not only facilitates installation and realizes high efficiency, but also ensures more firm connection for the hose and the hose joint on the premise of preventing the main body from excessively expanding the head end and influencing the service life due to fatigue of hose material. Thus, the hose and the hose joint are prevented from falling, and are difficult to get loose.

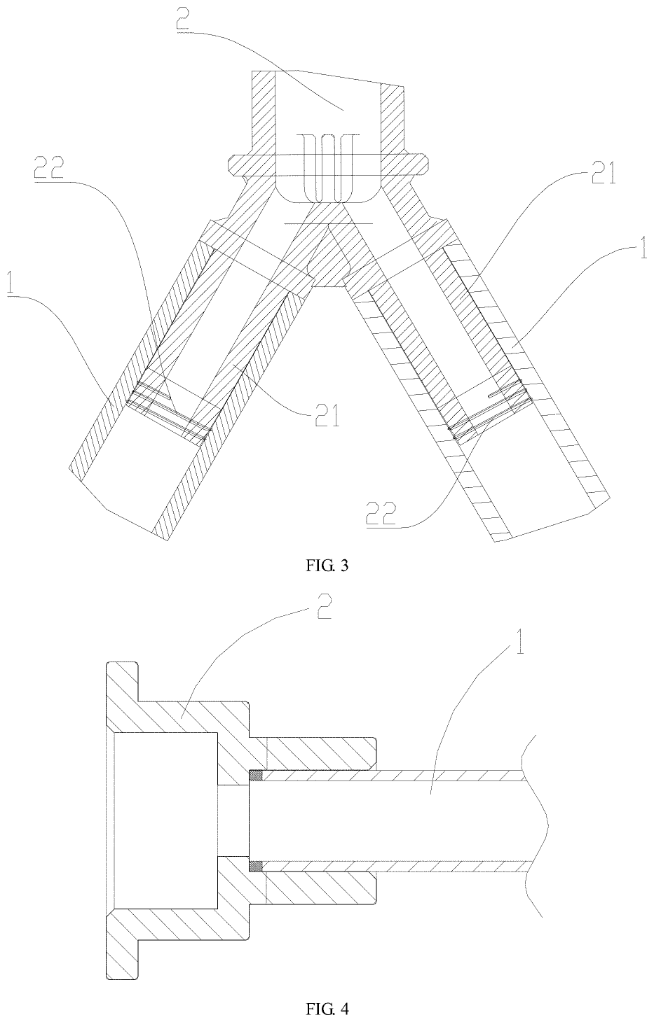

According to one embodiment of the present invention, as shown in FIG. 3, the hose joint 2 may be a T-joint which may comprise two connecting parts 21, so that the hose joint 2 may be connected with two hoses 1.

Optionally, in the present embodiment, the hose 1 and/or the connecting part 21 are made of the melting material which can be melted under the laser beams.

Or, as shown in FIG. 1, the outer surface of the connecting part 21 and/or the inner wall of the hose matched with the connecting part 21 is coated with a coating 23; and the coating 23 is made of the melting material which can be melted under the laser beams.

Through the adoption of the water passing component in the above technical solution, by means of the direct laser welding technology, the problems of poor welding strength, great deformation and no guarantee for sealing performance easily generated in a vibration friction welding technology, an ultrasonic welding technology and a hot plate welding technology in the related art can be solved. The transparency of the hose and the hose joint is not limited, and there is no requirement for the transparency of the hose and the hose joint, thereby reducing production cost and enhancing production quality. Moreover, the water passing component can also be applied to more forms of hoses and hose joints, thereby expanding the use range. In addition, general expansion straight insertion is changed into a screwing mode for connection with the hose, which not only enhances the convenience of technological operation, but also increases the limit burst pressure of the hose, so that sealing performance is strong and the appearance is beautiful.

As another embodiment, as shown in FIG. 4 to FIG. 5, the water passing component comprises a hose 1 and a hose joint 2 sleeved on the end part of the hose 1. The head end of the hose 1 and the tail end of the hose joint 2 are abutted against each other and are welded into a whole through melting. Moreover, the width of a gap of a weld matching surface between the head end of the hose 1 and the tail end of the hose joint 2 is less than 0.075 mm.

In the present embodiment, at least one of the hose 1 and the hose joint 2 is made of melting material which can be melted under the laser beams.

As shown in FIG. 5, at least one of the head end of the hose 1 and the tail end of the hose joint 2 is coated with a coating a made of the melting material which can be melted under the laser beams. Or, a melting element b made of the melting material which can be melted under the laser beams is arranged between the head end of the hose 1 and the tail end of the hose joint 2.

Through the adoption of the water passing component in the above technical solution, by means of the abutting welding mode, the problems of poor welding strength, great deformation and no guarantee for sealing performance easily generated in a vibration friction welding technology, an ultrasonic welding technology and a hot plate welding technology in the related art can be solved. The transparency of the hose and the hose joint is not limited, and there is no requirement for the transparency of the hose and the hose joint, thereby reducing production cost and enhancing production quality. Moreover, the water passing component can also be applied to more forms of hoses and hose joints, thereby expanding the use range.

In the embodiments of the present invention, the above water passing component is welded through the following welding manner.

As another example, the water passing component comprises a hose and a hose joint sleeved on the end part of the hose. The head end of the hose and the tail end of the hose joint are abutted against each other and are welded into a whole after the melting material is melted under laser beam irradiation.

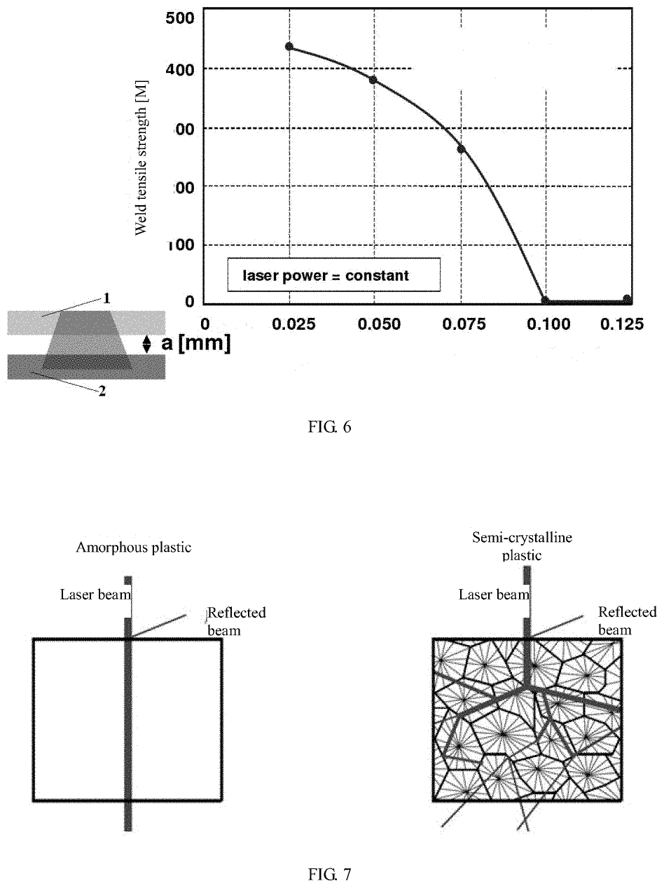

A relationship curve chart between the welding strength and the width of the gap of the weld matching surface is shown in FIG. 6.

As shown in FIG. 6, when the width of the gap of the weld matching surface between the head end of the hose and the tail end of the hose joint is less than 0.075 mm during melting welding, the tensile strength of the weld is larger than 250N.

As one example, the water passing component comprises a hose and a hose joint matched with the hose. The hose joint comprises a connecting part; the connecting part can extend into the hose and is closely matched with the inner wall of the hose; the head end of the outer surface of the connecting part is provided with a screw thread; and the screw thread rotatably slides along the inner wall of the hose when the hose joint rotates, to insert the connecting part into the hose and keep stable connection. The connecting and matching position of the connecting part and the hose can be melted under the laser beams to weld into a whole. For example, the hose and/or the connecting part are made of the melting material which can be melted under the laser beams. Or, the outer surface of the connecting part and/or the inner wall of the hose matched with the connecting part is coated with a coating; and the coating is made of the melting material which can be melted under the laser beams.

As one example, the melting material may be amorphous plastic or semi-crystalline plastic.

Reflected beams generated after the laser beams respectively irradiate the amorphous plastic and the semi-crystalline plastic are shown in FIG. 7.

As shown in FIG. 7, after the semi-crystalline plastic accepts laser irradiation, the reflected beam thereof can be repeatedly reflected in the melting material, so that the heated and melted region is wider.

As one embodiment, the melting material may be at least one of amorphous plastic such as polycarbonate (PC), polystyrene (PS), polysulfone (PAU), polymethylmethacrylate (PMMA) and ABS plastic, or at least one of semi-crystalline plastic such as polypropylene (PP), polyethene (PE) and polyamide (PA), and of course, can also be a mixture of the amorphous plastic and the semi-crystalline plastic. Optical performance and welding performance of different melting materials are compared and listed in Table 1 below.

TABLE 1
Table of Optical Performance and Welding Performance
of Different Melting Materials

| | Optical | Welding |
|---|---|---|
| Melting material | performance | performance |
| Polystyrene (PS) | ++ | ++ |
| Polyamide (PA) | + | ++ |
| Polybutylene terephthalate (PBT) | 0 | + |
| Styrene-acrylonitrile (SAN) | ++ | ++ |
| Polysulfone (PSU) | ++ | ++ |
| Acrylonitrile-butadiene-Styrene (ABS) | + | ++ |
| Mixture of polycarbonate (PC) and | ++ | ++ |
| acrylonitrile-butadiene-Styrene (ABS) | | |
| Mixture of polymethylmethacrylate | ++ | ++ |
| (PMMA) and | | |
| acrylonitrile-butadiene-Styrene (ABS) | | |

In Table 1, ++ indicates very good; + indicates good; and 0 indicates acceptable.

When the melting material is the semi-crystalline plastic, the influence of the microcrystal diameter on laser absorption performance is shown in FIG. 8.

As shown in FIG. 8, the laser absorption performance of the semi-crystalline plastic with a microcrystal diameter of 1-30 μm is obviously better than the laser absorption performance of the semi-crystalline plastic with a microcrystal diameter larger than 30 μm. The laser absorption performance of the semi-crystalline plastic with a microcrystal diameter less than 10 μm is best especially. Therefore, according to one embodiment of the present invention, when the melting material is the semi-crystalline plastic, the microcrystal diameter is 1-30 μm.

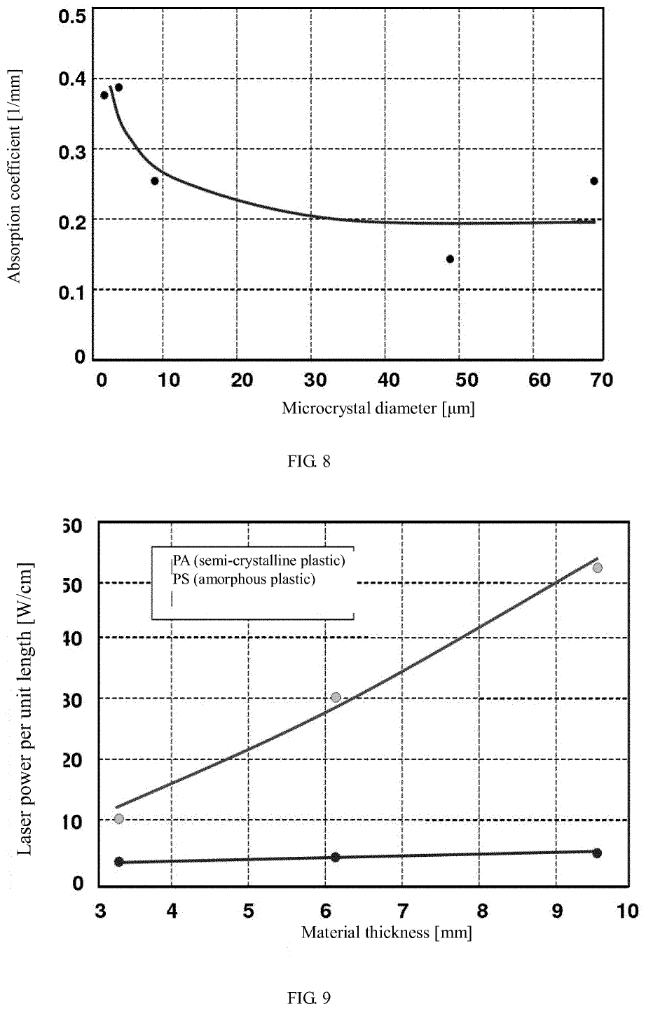

A relationship curve chart between the melting thickness of the melting material and the required laser power for the material thickness is shown in FIG. 9.

As shown in FIG. 9, for the amorphous plastic, because the laser beams are propagated therein in a straight line, the relationship between the laser power required for penetration and the thickness is not obvious.

However, for the semi-crystalline plastic, because the laser beams are repeatedly reflected therein, there is a very close relationship between the laser power required for penetration and the thickness. When the melting thickness of the melting material is 3-6 mm, the required laser power is less than 30 W/cm.

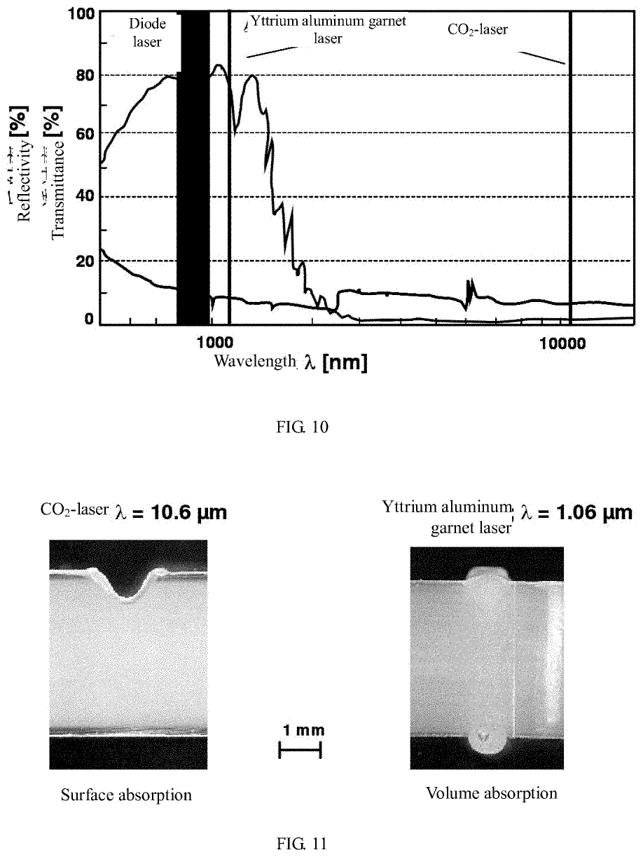

Comparison of the optical performance of three different light sources of the laser beams is shown in FIG. 10. Moreover, comparison of three different light sources of the laser beams is shown in Table 2.

TABLE 2
Table of Comparison of Three Different Light Sources

| | | Yttrium aluminum | |
|---|---|---|---|
| | CO₂ laser | garnet laser | Diode laser |
| Wavelength (μm) | 10.6 | 1.06 | 0.80-0.98 |
| Efficiency (%) | 5-10 | 1-3 | 30-50 |
| Density (dm³/kW) | 1000 | 100 | 1 |
| Resultant power | ≤30 | ≤3 | ≤3 |
| (kW) | | | |
| Price (DM/kW) | 150-500 | 150-800 | 80-500 |
| Maintenance | 1000 | 500 | Maintenance |
| period (h) | | | free |

Absorption effects of two different light sources are shown in FIG. 11.

In the present embodiment, based on the consideration of cost and efficiency, the light sources of the laser beams are yttrium aluminum garnet lasers or diode lasers; and the wavelength of the laser beams is 0.80-1.06 μm.

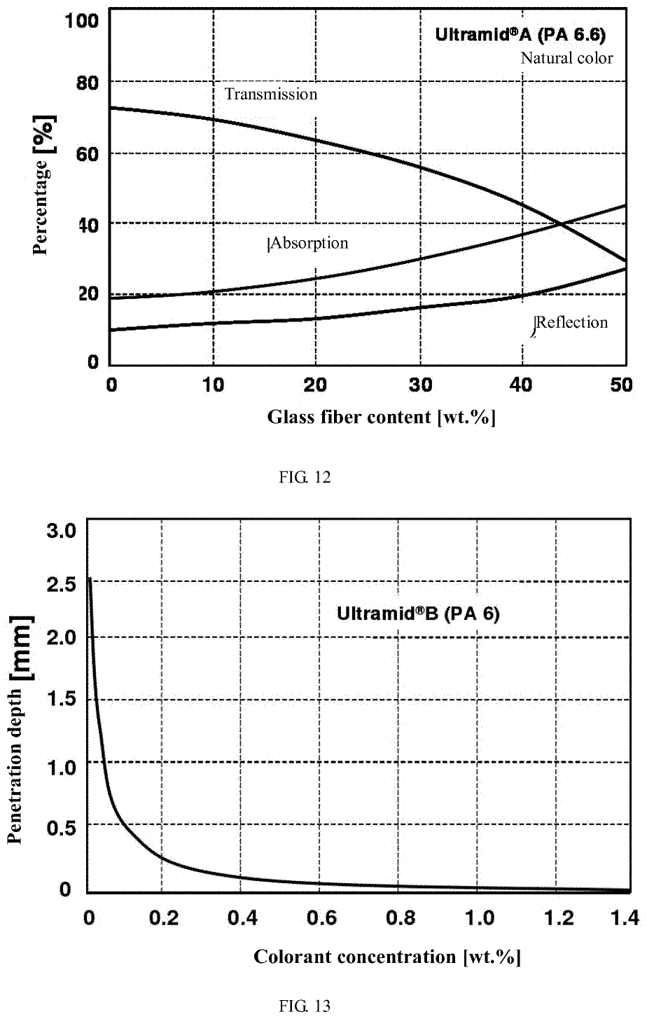

The relationship between the content of glass fibers in the melting material and the optical performance is shown in FIG. 12.

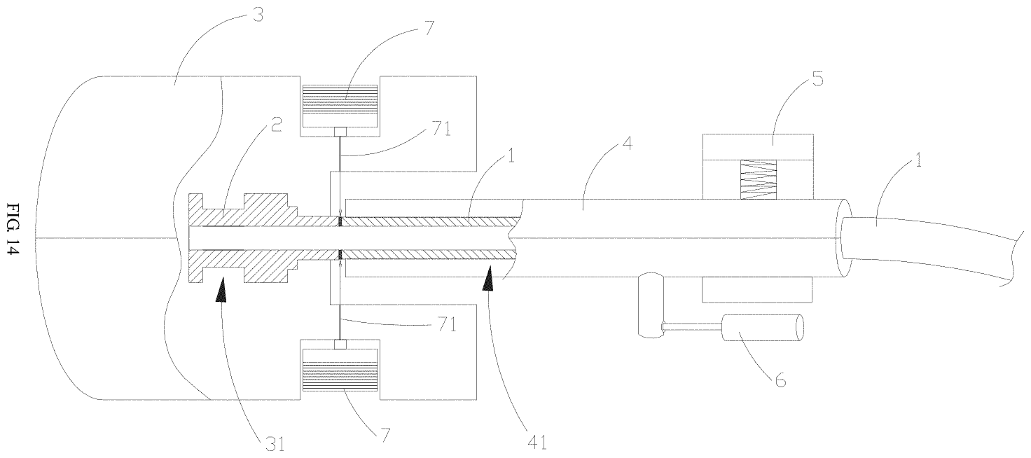

The relationship between the content of the colorant in the melting material and the optical performance is shown in FIG. 13.

By combining FIG. 12 and FIG. 13, in the present embodiment, the melting material contains 30 wt %-50 wt % of glass fiber; and the weight part of the colorant is less than 0.2%.

As another example, at least two yttrium aluminum garnet lasers or diode lasers are arranged; two or more yttrium aluminum garnet lasers or diode lasers are disposed along the external circumference of the hose joint; laser beams emitted by the yttrium aluminum garnet lasers or the diode lasers form an irradiating surface of 360° along the exterior of the hose joint; and the laser beams simultaneously irradiate the melting material from the exterior of the hose joint within one irradiating work cycle.

In the water passing component in the embodiments of the present invention, the hose joint is sleeved on the end part of the hose. One plane laser beam is adopted. During irradiation, the melting material of the abutting surface between the head end of the hose and the tail end of the hose joint is simultaneously melted. Thus, in the welding process, the water passing component does not need to rotate, thereby shortening the processing cycle, increasing the efficiency and avoiding insufficient melting of the melting material due to easy deviation generated in clamping and positioning the hose. Therefore, the manufactured connecting structure has a joint strength higher than 300 psi during a burst pressure test, and also has higher strength and better safety.

As one example, the hose joint comprises a connecting part; the connecting part can extend into the hose and is closely matched with the inner wall of the hose; the outer surface of the connecting part is provided with a screw thread; and the screw thread rotatably slides along the inner wall of the hose when the hose joint rotates, to insert the connecting part into the hose. At least two of the yttrium aluminum garnet lasers or diode lasers are disposed along the external circumference of the connecting and matching position; laser beams emitted by the yttrium aluminum garnet lasers or the diode lasers form an irradiating surface of 360° along the exterior of the connecting and matching position; and the laser beams simultaneously irradiate the melting material from the exterior of the connecting and matching position within one irradiating work cycle.

In the water passing component in the embodiments of the present invention, the general expansion straight insertion is changed into the screwing mode for connection with the hose, and one plane laser beam is adopted for irradiating the matching position. During irradiation, the melting material is simultaneously melted. Thus, in the welding process, the water passing component does not need to rotate, thereby shortening the processing cycle, increasing the efficiency and avoiding insufficient melting of the melting material due to easy deviation generated in clamping and positioning the hose. Therefore, the manufactured connecting structure has a joint strength higher than 300 psi during a burst pressure test, and also has higher strength and better safety.

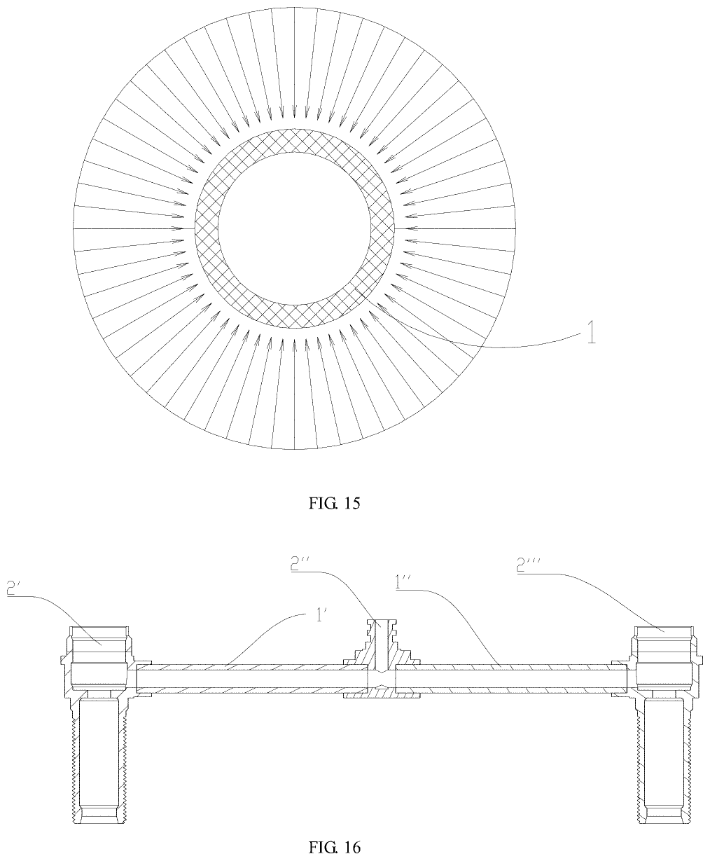

Specifically, as shown in FIG. 15, the laser light emitted by the lasers forms a plane laser beam distributed along the circumferential wall of the connecting and matching position. The laser beam irradiates the connecting and matching position to melt the melting material; and then the connecting and matching position of the connecting part and the hose are welded into a whole.

According to the water passing component in the embodiments of the present invention, the screw thread is arranged on the outer surface of the connecting part of the hose joint extended into the hose and closely matched with the inner wall of the hose. Thus, the general expansion straight insertion is changed into the screwing mode for connection with the hose, which not only facilitates installation and realizes high efficiency, but also ensures more firm connection for the hose and the hose joint on the premise of preventing the connecting part from excessively expanding the head end of the hose and influencing the service life due to fatigue of hose material. Moreover, the connecting and matching positions of the connecting part and the hose can be melted under the laser beams and welded into a whole. Thus, the transparency of the hose and the hose joint is not limited, and there is no requirement for the transparency of the hose and the hose joint, thereby reducing production cost and enhancing production quality. Moreover, the water passing component can also be applied to more forms of hoses and hose joints, thereby expanding the use range.

In addition, as one embodiment, as shown in FIG. 16, the water passing component in the embodiment comprises three water passing pipe joints (a first water passing pipe joint 2′, a second water passing pipe joint 2″ and a third water passing pipe joint 2′″) and two sections of water passing pipes (a first water passing pipe 1′ and a second water passing pipe 1″). One end part of the first water passing pipe 1′ and the tail end of the first water passing pipe joint 2′ are abutted against each other and are welded into a whole through melting. The other end part of the first water passing pipe 1′ and one tail end of the second water passing pipe joint 2″ are abutted against each other and are welded into a whole through melting. One end of the second water passing pipe 1″ and the other tail end of the second water passing pipe joint 2″ are abutted against each other and are welded into a whole through melting. The other end part of the second water passing pipe 1″ and the tail end of the third water passing pipe joint 2′″ are abutted against each other and are welded into a whole through melting.

Moreover, the width of a gap of a weld matching surface between the head end of the water passing pipe and the tail end of the water passing pipe joint is less than 0.075 mm.

As one embodiment, the water passing pipes and the water passing pipe joints may be made of high-performance high-molecular polymer plastic such as PA (polyamide), PP (polypropylene), PE (polyethene), PPA (polyphthalamide), PPO (polyphenylene oxide), POM (polyformaldehyde), etc.

In the present embodiment, at least one of the water passing pipe and the water passing pipe joint is made of the melting material which can be melted under the laser beams; or at least one of the head end of the water passing pipe and the tail end of the water passing pipe joint is coated with a coating made of the melting material which can be melted under the laser beams; or a melting element made of the melting material which can be melted under the laser beams is arranged between the head end of the water passing pipe and the tail end of the water passing pipe joint.

Through the adoption of the water passing component in the above technical solution, by means of the abutting welding mode, the problems of poor welding strength, great deformation and no guarantee for sealing performance easily generated in a vibration friction welding technology, an ultrasonic welding technology and a hot plate welding technology in the related art can be solved. The transparency of the water passing pipe and the water passing pipe joint is not limited, and there is no requirement for the transparency of the hose and the hose joint, thereby reducing production cost and enhancing production quality. Moreover, the water passing component can also be applied to more forms of water passing pipes and water passing pipe joints, thereby expanding the use range.

The above laser welding mode is realized in a laser welding device of the water passing component.

As shown in FIG. 14, the laser welding device comprises a hose joint clamping part 3 and a hose clamping part 4. Each of the hose joint clamping part 3 and the hose clamping part 4 is composed of more than two opening-closing clamping components.

The hose clamping part 4 is connected with a clamping mechanism 5, and the clamping mechanism 5 is used for controlling the opening-closing state of the hose clamping part 4.

Similarly, the hose joint clamping part 3 is also connected with a clamping mechanism for controlling the opening-closing state of the hose joint clamping part 3 (not shown in the figure).

A first holding cavity 31 for clamping and fixing the hose joint 2 is arranged in the hose joint clamping part 3.

The shape of the first holding cavity 31 is matched with the external shape of the hose joint 2.

A second holding cavity 41 for clamping and fixing the hose 1 is arranged in the hose clamping part 4.

The shape of the second holding cavity 41 is matched with the external shape of the hose 1.

The hose clamping part 4 can enter the hose joint clamping part 3 under the action of a drive device 6 and can enable the head end of the hose 1 clamped and fixed by the hose clamping part 4 to be opposite to and abutted against the tail end of the hose joint 2 clamped and fixed by the hose joint clamping part 3.

The side wall of the hose joint clamping part 3 is provided with slits 71 through which the laser beams passes.

The slits 71 are arranged along the circumference of the side wall of the hose joint clamping part 3.

A plurality of lasers 7 are uniformly arranged outside the slits 71.

As shown in FIG. 15, after the laser light emitted by the lasers passes through the slits 71, a plane laser beam distributed along the circumferential wall of the hose joint 2 is formed; the laser beams correspond to the abutting surface between the head end of the hose and the tail end of the hose joint; and when the laser beams irradiate, the melting material of the abutting surface between the head end of the hose and the tail end of the hose joint is simultaneously melted and then the head end of the hose and the tail end of the hose joint are welded into a whole.

In the laser welding device which adopts the water passing component of the above technical solution, after the laser light emitted by the lasers passes through the slits, a plane laser beam distributed along the circumferential wall of the hose joint is formed. During irradiation, the melting material of the abutting surface between the head end of the hose and the tail end of the hose joint is simultaneously melted. Thus, in the welding process, the water passing component does not need to rotate, thereby shortening the processing cycle, increasing the efficiency and avoiding insufficient melting of the melting material due to easy deviation generated in clamping and positioning the hose. Therefore, the manufactured connecting structure has a joint strength higher than 300 psi during a burst pressure test, and also has higher strength and better safety.

In addition, the embodiments of the present invention also propose a welding method of a water passing component. The water passing component comprises a hose and a hose joint sleeved to the end part of the hose and the welding method comprises the following steps: abutting the head end of the hose against the tail end of the hose joint, and welding into a whole after the melting material is melted under laser beam irradiation, wherein during melting welding, the width of a gap of a weld matching surface between the head end of the hose and the tail end of the hose joint is less than 0.075 mm; the melting thickness of the melting material is 3-6 mm; the light sources of the laser beams are yttrium aluminum garnet lasers or diode lasers; and the wavelength of the laser beams is 0.80-1.06 μm.

According to the welding method of the water passing component in the embodiments of the present invention, one plane laser beam is adopted. During irradiation, the melting material of the abutting surface between the head end of the hose and the tail end of the hose joint is simultaneously melted. Thus, in the welding process, the water passing component does not need to rotate, thereby shortening the processing cycle, increasing the efficiency and avoiding insufficient melting of the melting material due to easy deviation generated in clamping and positioning the hose. Therefore, the manufactured connecting structure has a joint strength higher than 300 psi during a burst pressure test, and also has higher strength and better safety.

In the illustration of this description, the illustration of reference terms “one embodiment”, “some embodiments”, “example”, “specific example” or “some examples”, etc. means that specific features, structures, materials or characteristics illustrated in combination with the embodiment or example are included in at least one embodiment or example of the present invention. In this description, exemplary statements for the above terms shall not be interpreted to aim at the same embodiment or example. Moreover, the described specific features, structures, materials or characteristics can be combined appropriately in any one or more embodiments or examples. In addition, those skilled in the art can combine and integrate different embodiments or examples illustrated in this description.

Although the embodiments of the present invention have been shown and described above, it will be appreciated that the above embodiments are exemplary and shall not be understood as limitations to the present invention. Those ordinary skilled in the art can make changes, amendments, replacements and variations to the above embodiments within the scope of the present invention.

What is claimed is:

1. A water passing component, comprising:
a hose; and
a hose joint,
wherein the hose joint and the hose are matched and connected to form a connecting and matching position; the connecting and matching position can be melted under laser beams to weld the hose and the hose joint into a whole; and the width of a gap of a weld matching surface corresponding to the connecting and matching position is less than 0.075 mm.

2. The water passing component according to claim 1, wherein the hose joint is sleeved on the end part of the hose, wherein the head end of the hose and the tail end of the hose joint are abutted against each other and are welded into a whole through melting; at least one of the hose and the hose joint is made of melting material which can be melted under the laser beams;
or at least one of the head end of the hose and the tail end of the hose joint is coated with a coating made of the melting material which can be melted under the laser beams;
or a melting element made of the melting material which can be melted under the laser beams is arranged between the head end of the hose and the tail end of the hose joint.

3. The water passing component according to claim 1, wherein the hose joint comprises a connecting part; the connecting part can extend into the hose and is closely matched with the inner wall of the hose; the outer surface of the connecting part is provided with a screw thread; and the screw thread rotatably slides along the inner wall of the hose when the hose joint rotates, to insert the connecting part into the hose.

4. The water passing component according to claim 2, wherein the melting thickness of the melting material is 3-6 mm; light sources of the laser beams are yttrium aluminum garnet lasers or diode lasers; and the wavelength of the laser beams is 0.80-1.06 μm.

5. The water passing component according to claim 4, wherein the melting material is amorphous plastic or semi-crystalline plastic.

6. The water passing component according to claim 5, wherein the melting material is at least one of polycarbonate, polystyrene, polysulfone, polymethylmethacrylate and ABS plastic, or at least one of polypropylene, polyethene and polyamide.

7. The water passing component according to claim 5, wherein when the melting material is the semi-crystalline plastic, a microcrystal diameter is 1-30 μm.

8. The water passing component according to claim 2, wherein the melting material also contains 30 wt %-50 wt % of glass fiber; and the weight part of a colorant in the melting material is less than 0.2%.

9. The water passing component according to claim 4, wherein at least two yttrium aluminum garnet lasers or diode lasers are arranged; the yttrium aluminum garnet lasers or the diode lasers are disposed along the external circumference of the hose joint; laser beams emitted by the yttrium aluminum garnet lasers or the diode lasers form an irradiating surface of 360° along the exterior of the hose joint; and the laser beams simultaneously irradiate the melting material from the exterior of the hose joint within one irradiating work cycle.

10. The water passing component according to claim 3, wherein the hose and/or the connecting part is made of melting material which can be melted under the laser beams, or
the outer surface of the connecting part and/or the inner wall of the hose matched with the connecting part is coated with the coating; and the coating is made of the melting material which can be melted under the laser beams.

11. The water passing component according to claim 10, wherein that the light sources of the laser beams are yttrium aluminum garnet lasers or diode lasers; and the wavelength of the laser beams is 0.80-1.06 μm.

12. The water passing component according to claim 10, wherein the melting thickness of the melting material is 3-6 mm.

13. The water passing component according to claim 10, wherein the melting material is amorphous plastic or semi-crystalline plastic.

14. The water passing component according to claim 13, wherein when the melting material is the semi-crystalline plastic, a microcrystal diameter is 1-30 μm.

15. The water passing component according to claim 3, wherein the screw thread is a tapping screw thread; and the tapping screw thread is arranged in the position of the head of the outer surface of the connecting part.

16. The water passing component according to claim 11, wherein at least two of the yttrium aluminum garnet lasers or diode lasers are disposed along the external circumference of the connecting and matching position; laser beams emitted by the yttrium aluminum garnet lasers or the diode lasers form an irradiating surface of 360° along the exterior of the connecting and matching position; and the laser beams simultaneously irradiate the melting material from the exterior of the connecting and matching position within one irradiating work cycle.

17. The water passing component according to claim 3, wherein the hose joint is a T-joint.

18. A laser welding device of a water passing component, comprising a hose joint clamping part and a hose clamping part; each of the hose joint clamping part and the hose clamping part is composed of more than two opening-closing clamping components; a first holding cavity for clamping and fixing the hose joint is arranged in the hose joint clamping part; the shape of the first holding cavity is matched with the external shape of the hose joint; a second holding cavity for clamping and fixing the hose is arranged in the hose clamping part; the shape of the second holding cavity is matched with the external shape of the hose; the hose clamping part can enter the hose joint clamping part under the action of a drive device and can enable the head end of the hose clamped and fixed by the hose clamping part to be opposite to and abutted against the tail end of the hose joint clamped and fixed by the hose joint clamping part; the side wall of the hose joint clamping part is provided with slits through which the laser beams passes; the slits are arranged along the circumference of the side wall of the hose joint clamping part; a plurality of lasers are uniformly arranged outside the slits; after the laser light emitted by the lasers passes through the slits, a plane laser beam distributed along the circumferential wall of the hose joint is formed; the laser beams correspond to the abutting surface between the head end of the hose and the tail end of the hose joint; and when the laser beams irradiate, the melting material of the abutting surface between the head end of the hose and the tail end of the hose joint is simultaneously melted and then the head end of the hose and the tail end of the hose joint are welded into a whole.

19. A welding method of a water passing component, wherein the water passing component comprises a hose and a hose joint sleeved to the end part of the hose and the welding method comprises the following steps:
abutting the head end of the hose against the tail end of the hose joint, and welding into a whole after the melting material is melted under laser beam irradiation, wherein during melting welding, the width of a gap of a weld matching surface between the head end of the hose and the tail end of the hose joint is less than 0.075 mm; the melting thickness of the melting material is 3-6 mm; the light sources of the laser beams are yttrium aluminum garnet lasers or diode lasers; and the wavelength of the laser beams is 0.80-1.06 μm.
